(19) United States
(12) Patent Application Publication
(10) Pub. No.: US 2005/0246434 A1
(43) Pub. Date: Nov. 3, 2005

(54) Services for capturing and modeling computer usage

(75) Inventors: David Fredrick Bantz, Portland, ME (US); Peter G. Capek, Ossining, NY (US); Thomas E. Chefalas, Somers, NY (US); David M. Chess, Mohegan Lake, NY (US); Christos Georgiou, Scarsdale, NY (US); William Grey, Millwood, NY (US); Steven J. Mastrianni, Unionville, CT (US); Paul Andrew Moskowitz, Yorktown Heights, NY (US); Clifford A. Pickover, Yorktown Heights, NY (US)

Correspondence Address: Louis P. Herzberg;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/818,159

(22) Filed: Apr. 5, 2004

(51) Int. Cl. G06F 7/60; G06F 17/10; G06F 15/173

(52) U.S. Cl. 709/223

(57) ABSTRACT

A subscriber to a service that monitors user behavior first registers with that service and selects a model of user behavior. The service then transmits that model to an agent, situated capable of monitoring user behavior and relating it to the model. After the monitoring interval the agent transmits data from the model to a server, where that data is summarized and reports created. These reports can then be sent to the subscriber in satisfaction of their needs for behavioral information.

### FIELD OF THE INVENTION

This application is directed to the field of computing systems. It is more specifically concerned with systems providing the service of monitoring user behavior.

### BACKGROUND OF THE INVENTION

There are many applications for accurate models of the behavior of a particular end user or of groups of end users of a computer system. An end user of a retail shopping Web site (e.g., Amazon.com) has certain buying and browsing patterns, and knowledge of these patterns (a user model) is advantageous to both the marketing functions of the Web site and to the resource allocation functions. An end user of a personal computer also has certain usage patterns, and knowledge of these patterns (a user model) is advantageous to both the user interface functions of the personal computer and to the resource allocation functions of the personal computer's operating system. There are many more such examples.

Models of user behavior can be of many forms. These models capture patterns of user behavior. One type of model that can be used in this way is a “finite-state automaton,” or “finite-state acceptor.” Other models describe user behavior using Bayesian networks. Regardless of the form of the model, for our purposes a model of user behavior is an executable or computational procedure driven by measurements of user interactions.

The advantages of accurate models of behavior accrue in many ways. They permit a personal computer system to anticipate user actions, making the personal computer appear to be more responsive to end user needs, simpler to operate and more “intelligent.” They permit targeted marketing to end users, reducing the “spam” that so plagues our Internet. If they can model end user behavior that is potentially destructive (e.g., hacking or planning a terrorist attack) they can even increase the personal security of all people subject to such attacks.

From the perspective of the user of behavioral models, the model must reflect the uses to which it will be put. Modeling time between keystrokes is of little or no interest to the detection of patterns of user behavior characteristic of hacking, while time between keystrokes can be quite valuable as a security measure. Patents have been granted which compare the keystroke cadence between authentic users and imposters when keying standard phrases well known to the authentic user. The differences in keying cadence are significant and can add to the confidence that the system is being used by a previously authenticated user.

Accordingly, it is desirable that modeling of user behavior be customized to its use. In today's practice, discrete models are created as programs and inserted in applications, the graphical user interface of a personal computer system, and in Web site processing. These models are hard to prepare, hard to validate, and inflexible in both modeling and their location in a network of computer devices. These attributes prevent more widespread modeling and thus deprive many potential beneficiaries from the information they capture.

It is desirable that customized models of user behavior be capable of distribution to the place where they can be employed. It is preferable that the model be distributed by electronic means. An example would be a state diagram in which each state represents a state of the interaction between the user and the computer system, augmented by state transition statistics documenting the relative frequency with which each transition from state to state has occurred during the time of measurement. The state diagram can be expressed as a matrix, and the matrix can be represented as an XML document.

Furthermore, some aspects of user behavior modeling may be considered by the modeled user to infringe upon that user's privacy. While it is unlikely that keystroke cadence would be considered an invasion of privacy, the user's browsing patterns on the Internet could be. Thus it is important in any scheme which models user behavior to reveal to the user what behavior is proposed to be captured and modeled and to what purpose, unless this modeling is specifically permitted through force of law.

In U.S. 2002/0032765A1, Pezzutti describes means by which an “intelligent” network can distinguish between sign-up behavior and normal usage of telecommunications services. Upon first access the user is granted sufficient privilege so as to be able to complete his or her registration for the service. Pezzutti is not concerned with general means for capturing user behavior.

In U.S. 2001/0017632 Goren-Bar describes building a “dynamic stereotype” user model in which user errors trigger help. Goren-bar's user model is fixed in function and not customizable in the aspects of user behavior it captures.

In U.S. Pat. No. 6,260,035 Horvitz et al. describes means by which user actions are aggregated into higher-level actions, then matched to a reasoning model to determine user state. One state of concern is the likelihood that the user needs assistance. While a rich and powerful model, it is not customizable to specific needs, is not described in standard form and is not deployable elsewhere in the network.

In U.S. Pat. No. 5,673,428 Hirakawa describes a separate unit for determining parameters of a user model in conjunction with an information-access system. Hirakawa's models are not customizable and network deployable.

U.S. Pat. No. 6,581,050 Horvitz et al. discloses a system for inferring the goals of a user when reading a text. Horvitz's system is coupled with a text classification system so that actual user behavior can be correlated with the type of text. Horvitz is not concerned with customizable user models, nor with network-deployable models.

Finally, U.S. 2001/0011211 A1 Bushey et al. describes the creation of a constellation of models, each appropriate to a different type of system user, and the means to determine a best fit between the user behavior and a model so as to classify the user. Bushey is not concerned with customizable models, nor with network-deployable models.

### SUMMARY OF THE INVENTION

Therefore, a first aspect of the present invention is to provide an infrastructure permitting widespread deployment of user behavior models, facilitating quick and inexpensive deployment and modification.

A second aspect of this invention provides features of this infrastructure that support end-user privacy, subject to the needs of law enforcement.

It is a further aspect of this invention to provide business models founded on the acquisition of user behavior information and the provision of that information to subscribers.

The invention discloses methods, systems and apparatus for the description of end-user behavioral models, the dissemination of such models to an agent and the acquisition and summarization of results by a server. These are enabled to support the privacy of the end user, subject to the needs of law enforcement, etc. The invention further provides means by which a service provider can receive descriptions of behavioral models from subscribers via a subscriber workstation, deploy these models, acquire results, and summarize and transmit these results to its subscribers. The results can be displayed on a subscriber workstation or stored on a subscriber server for subsequent analysis.

This invention makes it easier and generally less expensive to capture information about the behavior of an end user, subject to his or her needs for privacy. This, in turn, will make this information more broadly available, so that more providers of services can be responsive to the specific needs of their users. Alternate uses of this information, include detection of reckless or malicious behavior that is indicative of current or future criminal activity.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 shows a general disposition of components of the invention, including an end user system to be monitored, servers that initiate monitoring and capture data, and a subscriber to a service;

FIG. 2 shows an example of an overall process flow for an instance of a service;

FIG. 3 shows an example of libraries of information and their relationship to various servers required to provide the service;

FIG. 4 shows a fragment of an XML document exemplary of a behavioral model; and

FIG. 5 shows an example of a flow of processing for a agent, or probe, that monitors user behavior.

### DETAILED DESCRIPTION OF THE INVENTION

The present invention provides an infrastructure permitting widespread deployment of user behavior models, facilitating quick and inexpensive deployment and modification. It provides features of this infrastructure that support end-user privacy, subject to the needs of law enforcement. The invention also provides business models founded on the acquisition of user behavior information and the provision of that information to subscribers.

Example embodiments provide systems, apparatus and methods for the description of end-user behavioral models, the dissemination of such models to an agent and the acquisition and summarization of results by a server. These methods are specifically enabled to support the privacy of the end user, subject to the needs of law enforcement. The invention further provides the means by which a service provider can receive descriptions of behavioral models from subscribers via a subscriber workstation, deploy these models, acquire results, and summarize and transmit these results to its subscribers. The results can be displayed on a subscriber workstation or stored on a subscriber server for subsequent analysis.

The agent that monitors behavior can be located in a user's workstation, a network element or in a server. The monitored user's privacy can be safeguarded by soliciting the user's consent, optionally with compensation to the user, or otherwise verifying the authorization to monitor user behavior. Results can be summarized in reports of various kinds, including real-time, summary and individual behavior.

Generally, this makes it easier and less expensive to capture information about the behavior of an end user, subject to his or her needs for privacy. This, in turn, will make this information more broadly available, so that more providers of services can be responsive to the specific needs of their users. An example of an alternate use of this information is to detect reckless or malicious behavior that is indicative of current or future criminal activity.

The invention includes software and/or hardware that runs on a personal computing device, a network device and one or more servers. This software includes a probe, comprising a customizable model of user behavior; a deployment server, comprising descriptions of how to customize user models, a model monitor server, which receives data from user models and a subscription server which summarizes, filters and disseminates user behavior information to subscribers. In this context, a subscriber is some business entity wishing to avail itself of the services provided herein, namely the gathering and analysis of user behavior.

A key element of the invention is the platform-independent representation of a user behavior model in the XML document format. This representation can be automatically generated and deployed to probes, which interpret the document format and build custom behavioral models from it. A second key element of the invention is a platform-independent representation of subscriber needs for user behavior data, also in the XML document format. This document is transmitted from a subscriber to the subscription server as a guide to the summarization and filtering of actual gathered user behavior information.

The invention includes explanations of the behavioral models represented in the XML document format, so that the act of capturing user behavior can be described to the end user for his or her approval. A subscriber is solicited for approval. Optionally, this step can be omitted if the subscriber is authorized to capture user behavior through force of law, etc.

In an advantageous embodiment, probes are implemented in a portable implementation such as the Java programming language so that these probes can be deployed onto any platform supporting the Java runtime. A particularly advantageous embodiment of the invention, including a description of the method employed and the necessary apparatus will now be provided.

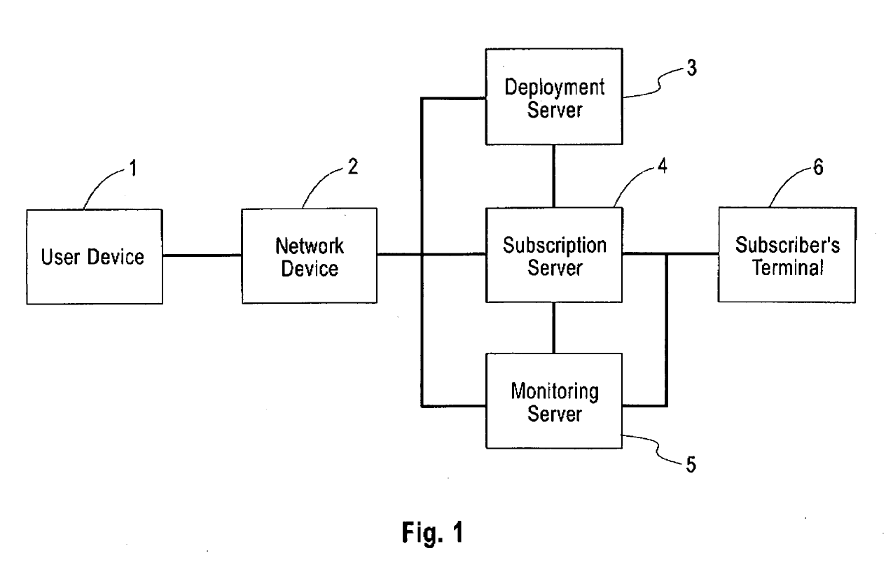

FIG. 1 shows the general configuration of components of the system implementing the subject invention. A user interacts with user device 1 and optionally with other devices not shown (e.g., other user devices, servers). One or more network devices 2 carry network traffic between the user device 1 and other devices. Deployment server 3 stores user behavioral models in XML format and at the command of subscription server 4 transmits these models to probes elsewhere in the system, typically in user devices 1, network devices 2 or servers not shown. The measurements taken by these models are transmitted to monitoring server 5. A subscriber interacts with subscriber's terminal 6 in order to originate requests for measurements to the subscription server 4 and to receive results from monitoring server 5.

The deployment server 3, subscription server 4 and monitoring server 5 of FIG. 1 are advantageously implemented with software such as IBM WebSphere Everyplace Server, Service Provider Edition, a product of the IBM Corporation. This product provides a framework for managing subscribers, deploying probes and monitoring probes, including security and wireless connectivity.

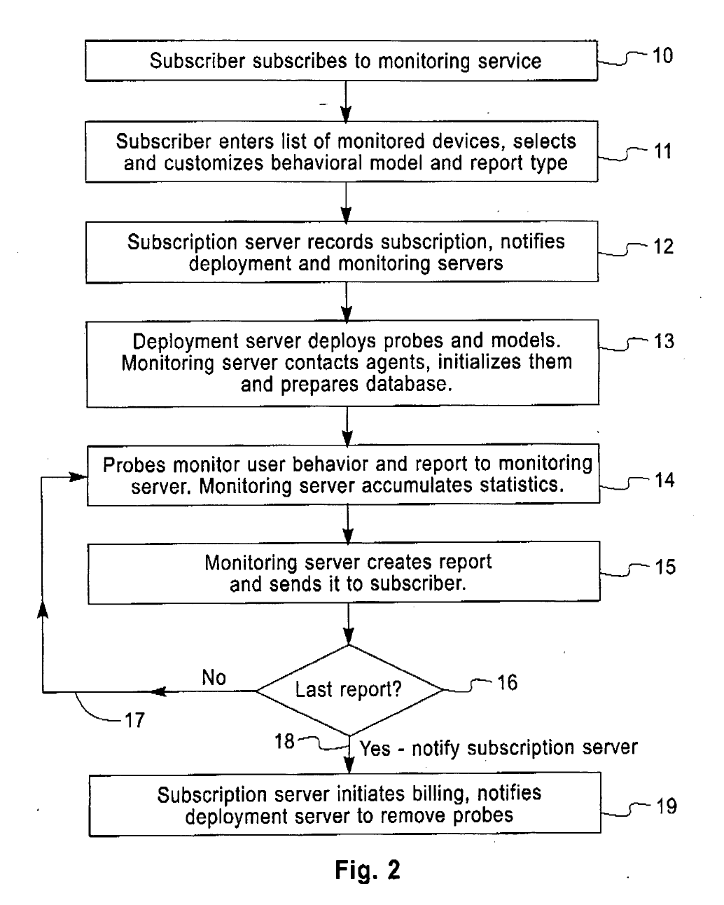

An overall processing flow advantageously implementing the subject invention is shown in FIG. 2. Processing begins with block 10, wherein the subscriber to the monitoring service contracts with that service for user behavior monitoring services, selecting types of services, payment plans and the like. The subscription is placed with subscription server 4 of FIG. 1, which has links not shown to permit validation of the subscriber's ability to pay and legal authorization to monitor user behavior. Block 11 of FIG. 2 causes the subscriber to select monitored devices or monitored users. The ability to select users to monitor is dependent on a directory service implemented elsewhere, often on the premises of an Internet Service Provider, which relates user identities to data identifying a network appearance of that user (e.g., IP address, userid). In block 11 the subscriber also selects the type and particulars of the behavioral model to be used from a library of such models. Given a selected model, the subscriber is then made aware of the statistical data available from that model and can select how he or she wishes that data to be reported.

Processing continues in block 12 wherein the subscription server records subscription information for later use, including report generation and billing. The subscription server notifies deployment server 3 of FIG. 1 of the devices into which probes are to be inserted, the type of probe, the customized model that the probe will carry, and its authorization to perform said actions. The subscription server notifies monitoring server 5 of FIG. 1 to expect statistics of given type from probes at given locations, and of the credentials probes will use to validate their transmissions.

Processing continues in block 13, not necessarily sequenced in the form illustrated in FIG. 2. Block 13 comprises processing actions in the deployment server 3 of FIG. 1 and the monitoring server 5 of FIG. 1. In practice, the processing in these two servers would proceed in parallel. In block 13 the deployment server validates the ability and willingness of each destination to accept a probe and deploys a probe to that location if possible. The deployment server then deploys models and customizations of those models via an XML description to each probe. In response to a subscription it may be the case that a number of probes of different types comprising different behavioral models need to be deployed, and that probes should be made aware of other probes so as to facilitate the transmission of data among them. This is also a responsibility of the deployment server.

Additionally in block 13 the monitoring server prepares tables and other data to be ready to receive data from the probes, aggregate and correlate that data, and record that data in a database. The monitoring server also prepares checks to validate that the data received is from a certified source and has not been tampered with during transmission. When it is ready, the monitoring server sends commands to each probe to initialize and start its monitoring.

Block 14 indicates that after the receipt of these initializing and starting commands, probes monitor user behavior and report statistics to the monitoring server. The monitoring server accumulates these statistics and stores them in its database. It may be that the subscriber has specified that monitoring activities are to take place during some defined period of time, or for some defined number of user interactions, or is to begin on the occurrence of some event. The event may be the initiation of a sales campaign, or the detection of an abnormal condition by some monitor not shown, or any other event whose occurrence would cause the need to acquire more detailed information about user behavior. It is the responsibility of the monitoring server 5 of FIG. 1 to detect the beginning and ending conditions for the subscription and to start and stop probes accordingly. Alternatively, this responsibility can be delegated to the probes.

Upon the occurrence of the end condition for the subscription, block 15 causes the monitoring server to send stop commands to all of the probes. The monitoring server then creates an interim report from its database and sends it to the subscriber. In block 16 a test is made to determine if the subscription is a continuing subscription including a number of monitoring intervals. If so, branch 17 is taken to restart the probes. If there is just one monitoring interval, or the current monitoring interval is the last, then branch 18 is taken and the monitoring server notifies the subscription server of the completion of the subscription.

In block 19, subsequent to the receipt of the notification from the monitoring server of the completion of the subscription, the subscription server notifies the subscriber of the completion of the subscription and initiates billing. The subscription server also notifies the deployment server to remove the probes. The removal of the probes may be subject to predictions of future use.

Recognizing that the subscription server 4 of FIG. 1 is advantageously implemented using the Tivoli Personalized Services Manager, a component of the WebSphere Everyplace Server, Service Provider Edition, we provide those functions of the subscription server that are particular to the subject invention and not otherwise described in IBM product descriptions.

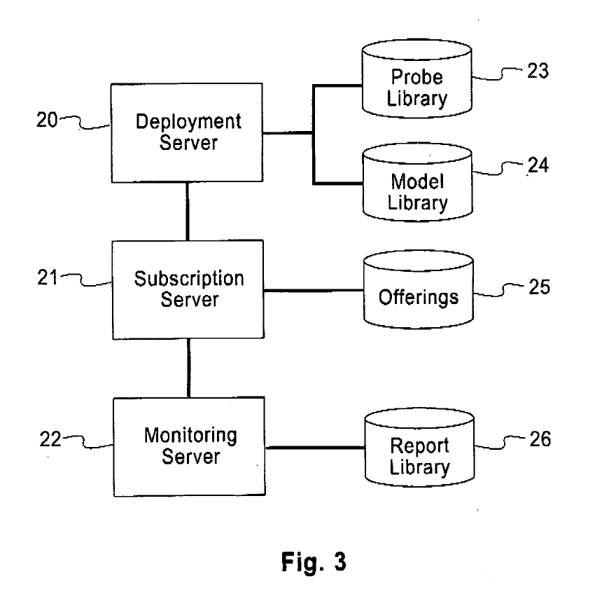

The subscription server 4 of FIG. 1 offers subscribers alternative services, based on the length and number of monitoring intervals, the number of users monitored and the complexity of the monitoring. Key to the subject invention is an association between the type of monitoring to be performed, selected by the subscriber at the time the subscription is negotiated, and the capabilities of the system to monitor user behavior. This capability is expressed in a library of probes, behavioral models and reports, maintained by the system, and a library of offerings, also maintained by the system. These libraries are depicted in FIG. 3.

FIG. 3 shows deployment server 20, subscription server 21, and monitoring server 22 identical in function to those servers as shown in FIG. 1. Also shown is a probe library 23 that comprises all available probes. Probes are portable software and/or hardware, also known as portable agents. The literature of mobile and portable agents is extensive. Portable agents are software and/or hardware that can be deployed into a wide variety of systems; mobile agents are portable agents that can change location after deployment. A multiplicity of probes is required because each probe can support only a limited range of models. FIG. 3 also shows a model library 24. Models are expressed as XML documents.

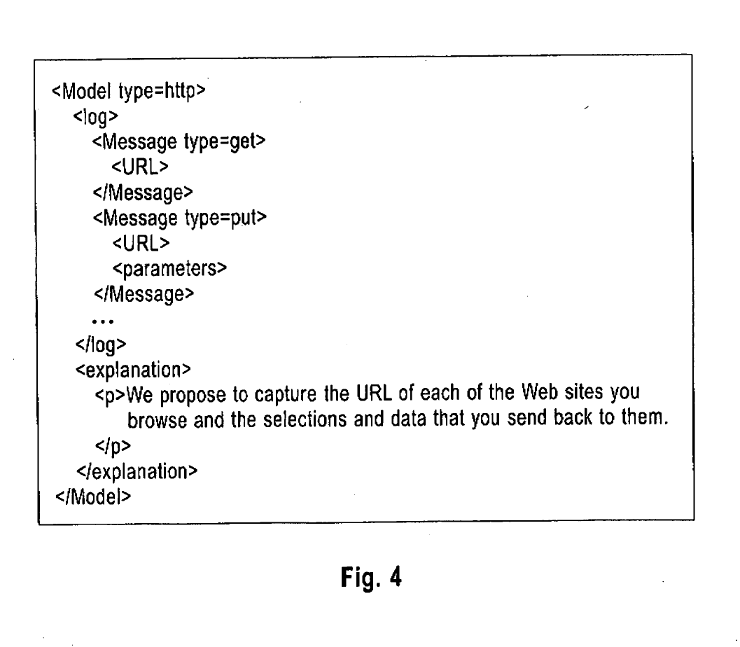

FIG. 4 is an example of an XML fragment used to define a model. In the figure, a model of type “HTTP” is specified. This is a very simple model for a probe that monitors HTTP traffic between the user and the Internet. The model only captures information from the stream of HTTP traffic. The “LOG” block specifies that only the HTTP “GET” and “PUT” messages are monitored, and that only the URL is captured from both message types. The parameters are also captured from PUT messages. Much more complex models can be defined using XML. In addition, different probe types may have built-in models of great sophistication. In this case the XML model definition merely supplies parameters and other customization to the existing model. By these means the behavioral models that can be deployed are essentially unlimited in functional capability.

As a second example of a model, consider the case where a subscriber is concerned with a specific item of content. It may be the case that the subscriber wants to know what the user behavior was when that item of content was encountered by the user, or may want to know whether the specific item of content is encountered during a specific form of user behavior. Such a model is built by augmenting the model of FIG. 4 with additional monitoring or capturing facilities. One form of monitoring language primitive is the “ON” condition, as found in the PL/1 programming language. Such a language primitive can specify a specific item of content or a defined range of content as the triggering condition, causing the model to capture user behavior subsequent to its satisfaction. Facilities for capturing what content is being accessed when some state of a finite-state acceptor is active would be similar to the LOG block of FIG. 4.

In a system such as this, there may be concerns about violations of the end user's privacy. Some of the data captured is normally aggregated, and when aggregated it is not possible to ascertain anything about the individual user's behavior. This is like the page hit counters that some Web sites maintain. Each user contributes to the counter, but since the counter aggregates, it is not possible to trace back anything to a particular user.

Also given in FIG. 4 is an explanation of the model. This explanation can be presented to the end user for his or her approval, so that the privacy concerns of the end user can be respected. If the end user rejects the model explicitly, or takes no action to approve it and thus rejects the model implicitly, this rejection is sent to the deployment server so that the requirements of the subscription can be satisfied. In some cases, users may only accept monitoring if compensated. If the subscription specified a fixed set of users or computers then the deployment server will not be able to satisfy the subscription request in its entirety, and so must notify the subscription server. If the requirements of the subscription can be substantially met without the participation of the rejecting end user, the subscription can proceed. Otherwise the subscriber is notified that their subscription request could not be fulfilled because of the rejection of monitoring by a specific user.

Note that if the subscription request is accompanied by verifiable data to the effect that this monitoring can be implemented without the consent of the user, the presentation of the explanation and subsequent request for approval can be suppressed. The invention may be used by certain agencies authorized to capture user behavior. The Department of Homeland Security is or can be authorized to capture the specifics of a user's behavior without the user's consent. This authorization must be authentic, and can originate from the monitored user. We do not address the authentication of the authorization (that is known to those skilled in the art) but do disclose mechanisms by which access to non-aggregated user behavior can be limited to those with authorization.

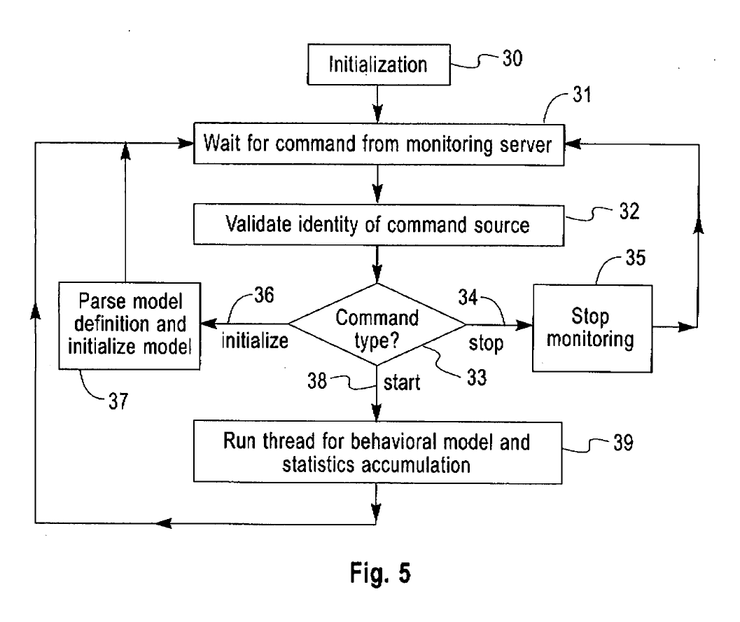

FIG. 5 shows processing typical of a probe. In block 30 the probe is initialized, including any subscriptions to events that it must place with the software and/or hardware environment in which it runs. A typical software environment is the Windows operating system. In block 31 the probe awaits commands from the monitoring server and in block 32 it validates the correctness of the command and the authenticity of the command source. In block 33 the command is decoded. If the command is an initialization command branch 36 is taken to block 37. Initialization commands are accompanied by an XML document representing a model. Block 37 parses the XML and constructs a model in executable form. After this is done block 31 is entered to wait for the next command from the monitoring server. If the command is a START command branch 38 is taken to block 39 that advantageously starts a thread of control on which the model runs. After this thread is started block 31 is entered to wait for the next command from the monitoring server. If the command is a stop command branch 34 is taken to block 35 that stops the thread of control on which the model runs and gathers statistics from the model. These statistics are then encoded as a second XML document and transmitted to the monitoring server.

Returning to FIG. 3, this figure also depicts an offerings database 25. This database comprises a listing of all of the services that subscribers can subscribe to, together with the probe(s), model(s), monitoring interval(s) and report(s) that are part of the service. When the subscriber chooses an offering the subscription server 21 notifies the deployment server 20 as to which probes and models to deploy, and notifies the monitoring server 22 which probes and models have been deployed and which reports to generate. Monitoring server 22 needs to know which probes and models have been deployed so that it can prepare to receive the data from those probes. Data formats may differ among probes. Subscription server 21 also notifies monitoring server 22 of the monitoring intervals that are defined as part of the current offering and as modified by directions from the subscriber. FIG. 3 also depicts a report library 26 that comprises definitions of which reports to generate when a monitoring interval ends. In an advantageous implementation, the contents of the report library 26 are XML documents describing the different report types.

Although the description so far concerns a mode of operation of the invention in which statistical data is captured and aggregated, and a report generated for the subscriber at the end of the subscription defined interval, there is another mode of operation, in which monitoring results are presented to the subscriber in real time or near-real time during the subscription interval. In this mode, the monitoring server computes results up to the present moment and makes those results available to the subscriber. These results can be updated at intervals convenient to the subscriber, so as to give a running summary of current user behavior to the subscriber. Thus, the invention includes methods and apparatus wherein the report is prepared and presented to the subscriber more than once during a period of measurement.

Some user behavior (e.g., keystrokes) must be captured by an agent in the workstation used by the user whose behavior is being monitored. Some user behavior (e.g., Web page accessing behavior) can be captured by a proxy in the user workstation, by a network monitor attached to the network the user is using or by network equipment, such as a router or gateway. Site-specific Web page accessing behavior can be captured by an agent in the Web server that supports the site. User communications activity can be captured by a network monitor or, in the case of wireless networks, by a simple RF activity monitor. In general, the location for the agent depends on the type of user behavior being monitored, and user behavior with respect to the devices with which the user directly interacts must be captured by an agent that has access to these devices, while user behavior that manifests itself as communication can be captured by network-resident resources as well.

The servers described above can be located anywhere, as long as they can receive messages from an agent. The server can be in the monitored user's workstation, in network resources, or in a datacenter. These servers can even be virtual, in that they can include a set of distributed processes that communicate with each other and run in multiple workstations or servers, as in the Grid. A typical packaging of the components of the invention includes agents running in the monitored user's workstation, agents running in network monitors, agents running in selected Web servers, and servers running in the datacenter for a service provider.

It can be seen that the description given above provides a simple, but complete implementation of a system for the monitoring of user behavior on a subscription basis. Note that any type of monitoring can be performed, as there are essentially no limitations on the capabilities of the probe and model. In particular, if the appropriate instrumentation is available data can be obtained about the user's physiological state. Instrumentation such as heart rate monitors, visual surveillance, galvanic skin resistance monitors, respiration rate monitors and other such devices can yield valuable insights as to the user's degree of arousal, stress and perplexity. The system described above can be deployed on a personal basis to assist the user in the operation of his or her personal computing device, on a household basis, to monitor the computer behavior of selected household members, on an enterprise scale, to monitor employees, or on a national scale for purposes of homeland defense.

The range of services that can be provided is considerable. In the simplest case, a subscriber to the service uses a subscriber workstation to contract with the service provider and to retrieve the communicable representations and analyses of user behavior. The subscriber may also use a subscriber server to retrieve and store the communicable representations and analyses of user behavior sent from the service provider, so that these representations and analyses can be made available for further dissemination and processing within the subscriber's organization.

Basic user behavior monitoring services report statistics for each monitoring interval, but services can be created to report only if a given event occurs (e.g., user heart rate exceeds 140 beats/minute). Streams of statistics can be analyzed in the monitoring server to extract complex events, such as a significant change in the user's behavior with respect to Internet browsing. The deployment of probes need not be limited to the user's personal computer or to network devices, but they may be deployed in Web servers as well, or alternatively. Probes are not limited to those which observe user behavior, but in fact can monitor any situation for which computer instrumentation exists, such as ambient temperature or lighting level.

Many business models are enabled by the system provided above. In particular, a business model in which the value of the service provided is inferred by a change in the user's physiological state is possible. Thus content which causes the user to be offended can be blocked in future interactions; content that the user finds interesting or exciting can be marketed to the user. Payment for a service can be linked to the favorable or unfavorable physiological states that the service causes to the user. Indeed, a user can be compensated for viewing material which the monitoring system determines to be offensive or otherwise undesirable.

It may be the case that several subscribers have interest in the same behavioral information from the same set of users, or that several subscribers have some overlap in their interest. It is not necessary for separate probes to be deployed for each subscription. As subscriptions are entered they can be checked for overlap with previous active subscriptions, and if overlap is detected (either by subscriptions to the same offering, or to the same user set, or other such overlap) the acquisition of user behavior information can be optimized. The simplest case is for a given probe to report to the monitoring server, where the monitoring server stores the reported data in multiple databases, one for each subscriber. This economizes on network bandwidth and the processing and storage impact of a probe on a monitored system. More complex cases can be dealt with through the definition of composite probes and models which gather information required for multiple subscribers simultaneously.

Thus the invention includes an apparatus comprising: a user behavior model represented in a communicable form; an agent to employ the user behavior model to capture behavior of a plurality of users; and a monitoring server communicatively coupled with the agent to receive and process information about behavior of at least one user from behavior captured by the agent, and to form processed user information.

In some embodiment, the apparatus further includes a subscriber workstation communicatively coupled with the monitoring server to receive the processed user information, wherein the processing of the information by the monitoring server transforms the processed user information into a format suitable for presentation to the subscriber workstation.

In some embodiment, the apparatus further includes a subscriber server communicatively coupled with the monitoring server to receive the processed user information, wherein the processing of the information by the monitoring server transforms the information into a format suitable for subsequent processing by the subscriber server.

In some embodiment of the apparatus, the agent is located in a user's workstation; and/or the agent obtains consent from said at least one user to capture behavior of said at least one user; and/or the monitoring server is responsive to a request from a subscriber, and verifies authorization of the subscriber to activate monitoring behavior of said at least one user; and/or the monitoring server verifies authorization in a manner responsive to satisfy user privacy; and/or at least one of: the user behavior model, the agent, and the monitoring server is maintained by a service provider, and wherein the monitoring server comprises a reporting module which provides a report to a plurality of service subscribers; and/or the report comprises data concerning the behavior of at least one of the plurality of users; and/or report comprises information aggregating and summarizing data concerning the behavior of at least one of said plurality of users; and/or the report comprises information specifically indicative of the behavior of at least one of said plurality of users, and is provided only to an authorized subscriber; and/or the agent approves compensation of said at least one user for the consent.

The invention also includes a method comprising: assigning and deploying at least one agent to capture behavior of a plurality of users; transmitting a model of user behavior for at least one of the plurality of users to said at least one agent; and activating said at least one agent to monitor and capture user behavior of said at least one users of the plurality of users.

In some embodiment of the method: the user behavior is represented in a behavior representation, and/or further comprises analyzing the behavior representation to form a report; and/or at least one step of the steps of: assigning, transmitting, activating and analyzing is performed by a service provider.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An apparatus comprising:
a user behavior model represented in a communicable form;
an agent to employ the user behavior model to capture behavior of at least one of a plurality of users; and
a monitoring server communicatively coupled with the agent to receive and process information about behavior of at least one user from behavior captured by the agent, and to form processed user information.

2. An apparatus as recited in claim 1, further comprising a subscriber workstation communicatively coupled with the monitoring server to receive the processed user information, wherein the processing of the information by the monitoring server transforms the processed user information into a format suitable for presentation to the subscriber workstation.

3. An apparatus as recited in claim 1, further comprising a subscriber server communicatively coupled with the monitoring server to receive the processed user information, wherein the processing of the information by the monitoring server transforms the information into a format suitable for subsequent processing by the subscriber server.

4. An apparatus as recited in claim 1, wherein the agent is located in a user's workstation

5. An apparatus as recited in claim 1, wherein the agent obtains consent from said at least one user to capture behavior of said at least one user.

6. An apparatus as recited in claim 5, wherein the monitoring server is responsive to a request from a subscriber, and verifies authorization of the subscriber to activate. monitoring behavior of said at least one user.

7. An apparatus as recited in claim 6, wherein the monitoring server verifies authorization in a manner responsive to satisfy user privacy.

8. An apparatus as recited in claim 1, wherein at least one of: said user behavior model; said agent; and said monitoring server is maintained by a service provider, and wherein said monitoring server comprises a reporting module which provides a report to a plurality of service subscribers.

9. An apparatus as recited in claim 8, wherein said report comprises data concerning the behavior of at least one of said plurality of users.

10. An apparatus as recited in claim 8, wherein said report comprises information aggregating and summarizing data concerning the behavior of at least one of said plurality of users.

11. An apparatus as recited in claim 8, wherein said report comprises information specifically indicative of the behavior of at least one of said plurality of users, and is provided only to an authorized subscriber.

12. A method comprising:
assigning and deploying at least one agent to capture behavior of a plurality of users;
transmitting a model of user behavior for at least one of said plurality of users to said at least one agent; and
activating said at least one agent to monitor and capture user behavior of said at least one users of said plurality of users.

13. A method as recited in claim 12, wherein said user behavior is represented in a behavior representation, and further comprising analyzing said behavior representation to form a report.

14. A method as recited in claim 13, wherein at least one step of the steps of: assigning, transmitting, activating and analyzing is performed by a service provider.

15. A method as recited in claim 14, further comprising providing a report to at least one subscriber from a plurality of service subscribers.

16. An apparatus as recited in claim 5, wherein said agent approves compensation of said at least one user for the consent.

17. An apparatus comprising:
means for assigning and deploying at least one agent to capture behavior of a plurality of users;
means for transmitting a model of user behavior for at least one of said plurality of users to said at least one agent; and
means for activating said at least one agent to monitor and capture user behavior of said at least one users of said plurality of users, said user behavior being represented in a behavior representation.

18. An article of manufacture comprising a computer usable medium having computer readable program code means embodied therein for causing capture of behavior, the computer readable program code means in said article of manufacture comprising computer readable program code means for causing a computer to effect the steps of:
assigning and deploying at least one agent to capture behavior of a plurality of users;
transmitting a model of user behavior for at least one of said plurality of users to said at least one agent; and
activating said at least one agent to monitor and capture user behavior of said at least one users of said plurality of users.

19. A computer program product comprising a computer usable medium having computer readable program code means embodied therein for causing formation of processed user information, the computer readable program code means in said computer program product comprising computer readable program code means for causing a computer to effect the functions of:
a user behavior model represented in a communicable form;
an agent to employ the user behavior model to capture behavior of at least one of a plurality of users; and
a monitoring server communicatively coupled with the agent to receive and process information about behavior of at least one user from behavior captured by the agent, and to form processed user information.

20. A method for characterizing user behavior, said method comprising;
a user interacting with at least one user input device;
at least one network device carrying network traffic originating at said at least one user input device and destined to at least one other device;
storing at least one of a plurality of user behavioral models;
responsive to a command, transmitting at least one user behavioral model to at least one probe in the network;
transmitting measurements taken by said at least one probe to a monitoring server; and
a subscriber interacting with a subscriber's terminal in order to originate requests for the measurements and receiving at least one report derived from said measurements.

21. An article of manufacture comprising a computer usable medium having computer readable program code means embodied therein for causing capture of behavior, the computer readable program code means in said article of manufacture comprising computer readable program code means for causing a computer to effect the steps of:
a user interacting with at least one user input device;
at least one network device carrying network traffic originating at said at least one user input device and destined to at least one other device;
storing at least one of a plurality of user behavioral models;
responsive to a command, transmitting at least one user behavioral model to at least one probe in the network;
transmitting measurements taken by said at least one probe to a monitoring server; and
a subscriber interacting with a subscriber's terminal in order to originate requests for the measurements and receiving at least one report derived from said measurements.

22. A method for modeling user behavior, said method comprising:
at least one subscriber placing a subscription to a service and contracting with the service for user behavior monitoring services;
said at least one subscriber selecting at least one monitoring device, at least one user to be monitored, and at least one behavioral model to be used for each said at least one user;
a subscription server notifying a monitoring server to expect data of a given type from said at least one monitoring device, and notifying the monitoring server of credentials said at least one monitoring device will use to validate transmissions of said at least one monitoring device for said at least one subscriber.

23. A method as recited in claim 22, further comprising validating the ability and willingness of monitoring device to accept a respective behavioral model and deploying said respective behavioral model to said each location.

24. A method as recited in claim 22, further comprising the monitoring server aggregating and correlating said data, recording said data, and preparing checks to validate that said data received is from a certified source and has not been tampered with during transmission;
the monitoring server sending commands to each monitoring device to initialize and start its monitoring function for said subscriber; and
said monitoring device monitoring user behavior and reporting statistical data to the monitoring server.

25. A method as recited in claim 22, further comprising the monitoring server accumulating said statistical data and storing it in its database, detecting beginning and ending conditions for said subscription; and starting and stopping said monitoring devices accordingly.

26. A method as recited in claim 22, wherein the step of placing includes validating the subscriber's ability to pay and the subscriber's authorization to monitor said user behavior.

27. A method as recited in claim 22, wherein the step of selecting a user to be monitored includes employing a directory service.

28. An article of manufacture comprising a computer usable medium having computer readable program code means embodied therein for causing capture of behavior, the computer readable program code means in said article of manufacture comprising computer readable program code means for causing a computer to effect the steps of:
at least one subscriber placing a subscription to a service and contracting with the service for user behavior monitoring services;
said at least one subscriber selecting at least one monitoring device, at least one user to be monitored, and at least one behavioral model to be used for each said at least one user;
a subscription server notifying a monitoring server to expect data of a given type from said at least one monitoring device, and notifying the monitoring server of credentials
said at least one monitoring device will use to validate transmissions of said at least one monitoring device for said at least one subscriber.

29. A method as recited in claim 20, wherein said at least one report is prepared and presented to the subscriber during a period of measurement, and said at least one report being prepared from data available up to the time of the preparation of the report.
